(19) United States
(12) Patent Application Publication
(10) Pub. No.: US 2023/0318819 A1
(43) Pub. Date: Oct. 5, 2023

(54) ONE-TIME PROGRAMMING (OTP) KEY REVOCATION FROM A TWO-DIMENSIONAL KEY STORAGE STRUCTURE OF A SYSTEM ON A CHIP (SOC)

(71) Applicant: Fortinet, Inc., Sunnyvale, CA (US)

(72) Inventors: Dengxue Yan, San Jose, CA (US); Zengli Duan, Monte Sereno, CA (US)

(21) Appl. No.: 17/710,656

(22) Filed: Mar. 31, 2022

(51) Int. Cl. H04L 9/08; H04L 9/32; G06F 9/4401

(52) U.S. Cl. CPC H04L 9/0863; H04L 9/088; H04L 9/0894; H04L 9/3236; G06F 9/4401

(57) ABSTRACT

A substrate for the SoC includes one or more OTP modules within the substate and comprising memory that can only be programmed once. A BIOS module loads a special BIOS into flash memory in place of a normal BIOS prior to a reboot of the OTP hardware module. The special BIOS is programmed to identify a status bit to burn corresponding to a revoked key. A first key register stored in the OTP module and comprising a plurality of status bits. Each status bit maps to the individual key of the plurality of OTP keys. A key burn module to burn a status bit on the key register corresponding to the special BIOS after the reboot. The BIOS module reloads the normal BIOS into the flash memory in place of the special BIOS prior to a second reboot. The normal BIOS runs after the second reboot.

### FIELD OF THE INVENTION

The invention relates generally to computer networking, and more specifically, for SoC having on-die one-time programming (OTP) hardware with two-dimensional key revocation allowing revocation of OTP keys.

### BACKGROUND

An OTP hardware memory is often integrated into a system on a chip (SoC) for key storage. An advantage of OTP memory over reprogrammable memory, such as flash memory, are smaller area and no additional wafer processing steps on the SoC. OTP thus has replaced multi-time programmable memory in many low-cost applications.

For security applications, OTP is preferred because it cannot be hacked using passing, semi-invasive and invasive measures. Chips that need encryption keys or other unique identifiers, need to be individually programmed by storing in OTP during chip manufacturing or afterwards.

One problem with OTP arises during key revoking. For example, a key or keys expire or are leaked. Then a new key or new keys are needed while the old key will be invalidated. Since OTP device is one time programmable, the existing key in the OTP device cannot be directly erased and replaced.

Therefore, what is needed is a robust technique for SoC having on-die OTP hardware with two-dimensional key revocation allowing revocation of OTP keys.

### SUMMARY

These shortcomings are addressed by the present disclosure of methods, computer program products, and systems for SoC having on-die OTP hardware with two-dimensional key revocation allowing revocation of OTP keys.

In one embodiment, a substrate for the SoC includes one or more OTP modules within the substate and comprising memory that can only be programmed once. The OTP module comprises a plurality of key storage regions, each key storage region dedicated to an individual key of a plurality of OTP keys. A BIOS module to load a special BIOS into flash memory in place of a normal BIOS prior to a reboot of the OTP hardware module. The special BIOS is programmed to identify a status bit to burn corresponding to a revoked key.

In another embodiment, a first key register stored in the OTP module and comprising a plurality of status bits. Each status bit maps to the individual key of the plurality of OTP keys. A key burn module to burn a status bit on the key register corresponding to the special BIOS after the reboot. The BIOS module reloads the normal BIOS into the flash memory in place of the special BIOS prior to a second reboot. The normal BIOS runs after the second reboot. The OTP module subsequently authenticates the normal BIOS based on the plurality of keys other than the revoked key after the second reboot.

Advantageously, semiconductor manufacturing processes are improved by reducing dead chips. Additionally, computer device performance is improved with smaller processors.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a system for verifying and authenticating a RAMBOOT on a virtual OTP prior to enabling an OTP hardware module for RAMBOOT boot up, according to an embodiment.

FIG. 2 is a more detailed block diagram illustrating a RAMBOOT module of the system of FIG. 1, according to an embodiment.

FIG. 3 is a more detailed block diagram illustrating an SoC having on-die OTP hardware with two-dimensional key revocation allowing revocation of OTP keys, according to an embodiment.

FIG. 4 is a high-level block diagram illustrating a computing device as an example hardware implementation of the SoC herein, according to an embodiment.

FIG. 5 is a high-level flow diagram illustrating a method for verifying and authenticating a RAMBOOT by the key or key hash stored on a virtual OTP prior to enabling OTP hardware module for RAMBOOT boot up, according to an embodiment.

FIG. 6 is a high-level flow diagram illustrating a method for enabling the key or key hash on the OTP device for RAMBOOT boot up, according to one preferred embodiment.

FIG. 7 is a more detailed flow diagram illustrating a step of authenticating an unauthenticated RAMBOOT boot up, according to one embodiment.

FIG. 8 is a high-level flow diagram illustrating a method for revoking a first level key on an SoC having on-die OTP hardware with two-dimensional key revocation, according to an embodiment.

FIGS. 9A & 9B together form a high-level flow diagram illustrating a method for revoking a second level key on an SoC having on-die OTP hardware with two-dimensional key revocation, according to an embodiment.

### DETAILED DESCRIPTION

The description below provides methods, computer program products, and systems for verifying and authenticating a RAMBOOT on a virtual OTP prior to enabling an OTP hardware module for RAMBOOT boot up.

One of ordinary skill in the art will recognize many additional variations made possible by the succinct description of techniques below.

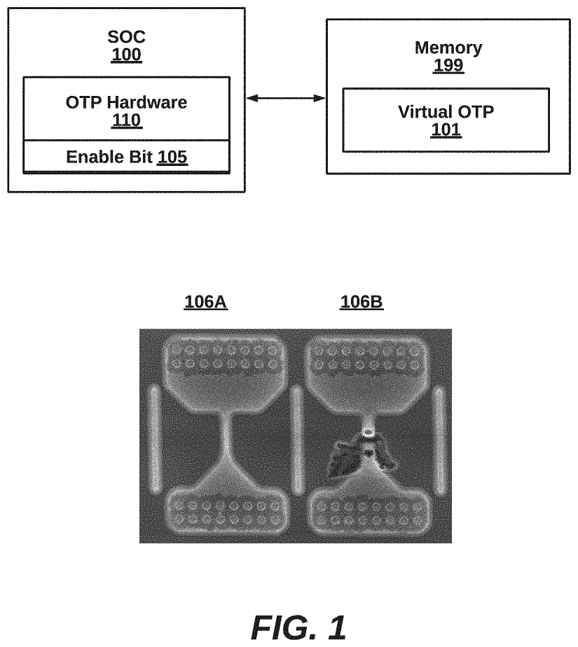

I. Systems for Two-Dimensional OTP Key Revocation (FIGS. 1-4)

FIG. 1 is a block diagram illustrating an SoC 100 for verifying and authenticating a RAMBOOT by the key or key hash stored on a virtual OTP prior to enabling the OTP hardware module for RAMBOOT boot up, according to an embodiment. The system 100 includes an SoC 100 and an off-chip memory 199. In other embodiments, memory is on-chip as part of the SoC 100 by integration, or memory on the same motherboard as the SoC 100.

In one embodiment, the off-chip memory 199 executes the virtual OTP prior to committing to the OTP on chip. The off-chip memory comprises a USB drive plugged into a USB port communicatively connected to the SoC 100. In other embodiments, the off-chip memory 199 comprises SPI flash, eMMC, SD, RAM, and the like.

The SoC 100 can generate OTP device content for programming into the virtual OTP. A boot up procedure inside the SoC 100 uses the virtual OTP device to verify/authenticate the system. Authenticated content is programmed into the OTP device on chip and enables burns a fuse bit.

The SoC 100 has many different uses, such as a security chip providing a firewall in network device hardware or IPsecVPN. Generally, an SoC is an integrated circuit that integrates all or most components of a computer system. The SoC 100 can be a semiconductor device used to operate a network device, a computer, a smartphone, an airplane, as non-limiting examples. After design, the SoC 100 can be etched into a silicon substrate, and then deployed.

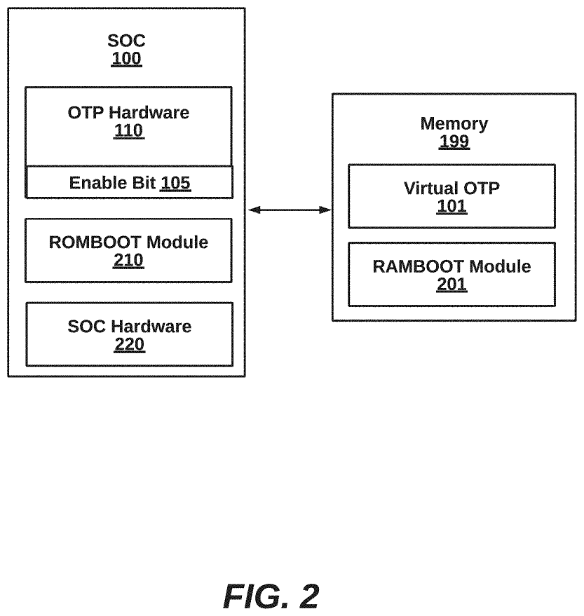

FIG. 2 is a more detailed block diagram illustrating the components of the system 100 of FIG. 1, according to an embodiment. Besides the OTP hardware 130, the SoC 100 further comprises a RAMBOOT module 220, OTP hardware 130, and SoC hardware 230.

The OTP hardware 110, in one example, is a type of non-volatile memory that comprises of electrical fuse (eFuse) or antifuse. One or more arrays can be arranged using differential paired eFuse cells with single or dual ports with 0.18 micron CMOS technology or the like. Besides cell arrays, a control logic, a column decoder, and a program data driver circuit also add to the operation. An amount of storage is implementation-specific, for example, between 8 bits, 512 bits and 4 kbits.

The RAMBOOT module 210 determines whether the OTP device that is used to authenticate RAMBOOT bootup has been enabled in the OTP hardware 130 for standard booting. Responsive to not being enabled, the RAMBOOT module 210 precludes OTP hardware boot up in favor of the virtual OTP boot up. The RAMBOOT module 210 next determines whether the RAMBOOT bootup is authenticated by the key or key hash stored in the virtual. Responsive to not being authenticated, authentication of the RAMBOOT bootup is initiated, and responsive to being authenticated, enablement of the OTP device is initiated. The RAMBOOT module is read-only.

The RAMBOOT module 220, for unauthenticated RAMBOOT boot up, checks a certificate for validity. Keys are extracted from the certificate and a key image is formed. The key image is programed into storage for recognition by RAMBOOT. A key image hash is calculated and programmed into the virtual OTP. The system will then automatically reboot.

The RAMBOOT module 220, once the RAMBOOT boot up has been authenticated and the system rebooted, copies source code and compares after copying for accuracy. If the content does not match, the RAMBOOT module 220 will retry or notify a user and wait for user commands. For verified matching content, the system will enable the OTP hardware 130. To do so, a low resistance metal in eFuse is blown by electro-migration because the high-density current flows through a narrow metal or poly (e.g., a bone layout). When using high-k metal gate CMOS logic process, there is no polysilicon layer to be used as eFuse, and metal traces can be used. The system will then automatically reboot again.

The SoC hardware 130 comprises additional chip components necessary for implementation on the common die. One or more processors or controllers is needed to coordinate the SoC 100, and memory is needed on chip. Depending on the specifications, wireless transceivers, power management modules, busses and other components can be included within the single die.

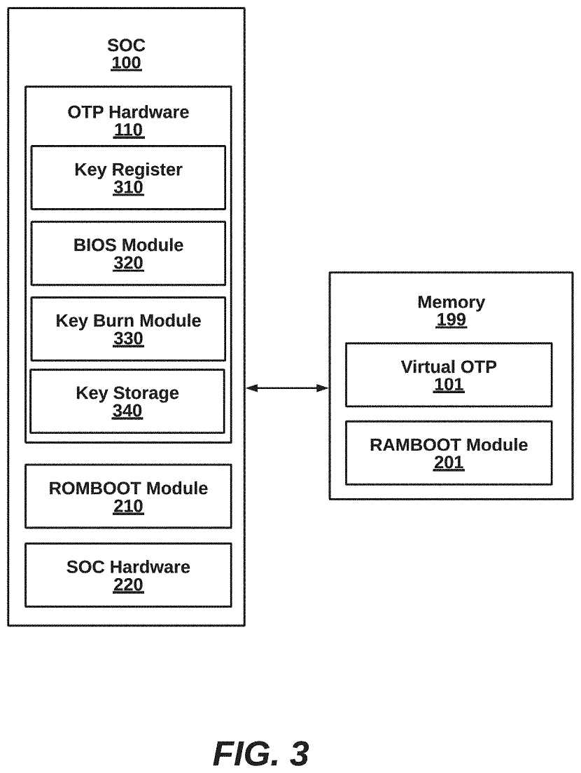

FIG. 3 is a high-level block diagram illustrating an SoC having on-die OTP hardware with two-dimensional key revocation allowing revocation of OTP keys, according to an embodiment.

The OTP module 110 within the substate and comprising memory that can only be programmed once. The memory comprises a plurality of regions, each region is dedicated to an individual key of a plurality of OTP keys.

The key register 310 stored in the OTP module 110 and comprising a plurality of status bits. Each of the status bit maps to the individual key of the plurality of OTP keys. A second key register comprises a plurality of status bits each mapping to a key group, such that when a status bit is burned, the key group is invalidated.

The BIOS module 320 to load a special BIOS into flash memory in place of a normal BIOS prior to a reboot of the OTP hardware module. The special BIOS is programmed to identify a status bit to burn corresponding to a revoked key. In another embodiment, a first special BIOS corresponds to a revoked key group and a second special BIOS corresponds to a revoked key.

The key burn module 330 to burn a status bit on the key register corresponding to the special BIOS after the reboot. A next key is burned from a next valid key group, in one case. The BIOS module reloads the normal BIOS into the flash memory in place of the special BIOS prior to a second reboot.

The normal BIOS runs after the second reboot. During normal operation, invalid key groups are ignored and keys are used sequentially until a valid key of the valid key group is found.

The OTP module authenticates the normal BIOS based on the plurality of keys other than the revoked key after the second reboot. In one case, the BIOS module 320 burns a key status bit and a key group status bit within a single boot up. In another case, the status bit and the key group bit are burned on different boots ups using different BIOS code (e.g., first special BIOS and second special BIOS).

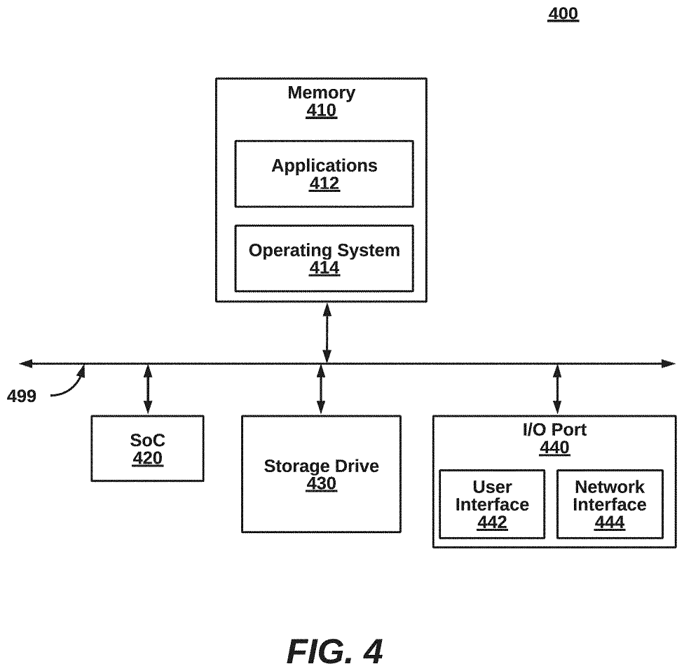

FIG. 4 is a block diagram illustrating a computing device 400 capable of implementing components of the system, according to an embodiment. The computing device 400, of the present embodiment, includes a memory 410, a processor 420, a storage drive 430, and an I/O port 440. Each of the components is coupled for electronic communication via a bus 499. Communication can be digital and/or analog and use any suitable protocol. The computing device 400 can incorporate the components discussed herein (e.g., the SoC 100), other networking devices (e.g., an access point, a firewall device, a gateway, a router, or a wireless station), or a disconnected device.

Network applications 412 (e.g., the load balancing engine 112) can be network browsers, daemons communicating with other network devices, network protocol software, and the like. An operating system 414 within the computing device 400 executes software, processes. Standard components of the real OS environment 414 include an API module, a process list, a hardware information module, a firmware information module, and a file system. The operating system 414 can be FORTIOS, one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The storage drive 430 can be any non-volatile type of storage such as a magnetic disc, EEPROM (electronically erasable programmable read-only memory), Flash, or the like. The storage drive 430 stores code and data for applications.

The I/O port 440 further comprises a user interface 442 and a network interface 444. The user interface 442 can output to a display device and receive input from, for example, a keyboard. The network interface 444 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPsec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

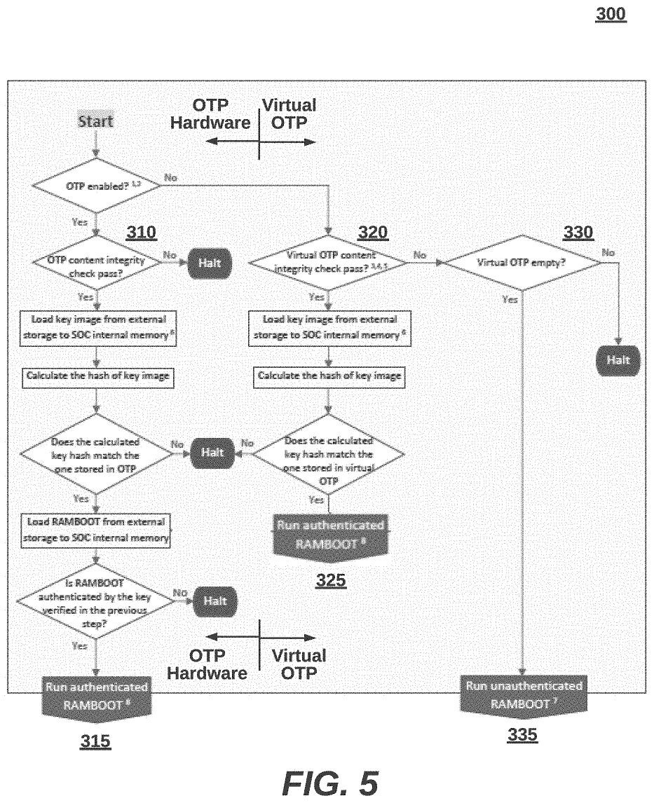

II. Methods for Two-Dimensional OTP Key Revocation (FIGS. 5-8)

FIG. 5 is a high-level flow diagram illustrating a method 500 for verifying and authenticating a RAMBOOT by the key or key hash on a virtual OTP prior to enabling the OTP hardware module for RAMBOOT boot, according to one preferred embodiment. The method 500 can be implemented, for example, by the RAMBOOT module 210 of SoC device 100 or another write once then read-only device. The steps are merely representative groupings of functionality, as there can be more or fewer steps, and the steps can be performed in different orders. Many other variations of the method 500 are possible.

At step 510, it is determined whether the content on OTP device has been enabled, and responsive to not being enabled, normal RAMBOOT bootup is precluded for the on-chip OTP hardware. At step 520, it is determined whether the RAMBOOT boot up has been authenticated. Responsive to not being authenticated, at step 530, authentication of the RAMBOOT bootup is initiated. At step 525, a key is generated and stored for subsequent authentications. Responsive to being authenticated, at step 515, enablement of the RAMBOOT boot up authenticated from on chip OTP hardware is initiated. Responsive to the OTP device being enabled, at step 515, RAMBOOT boot up authenticated from the on-chip OTP is initiated.

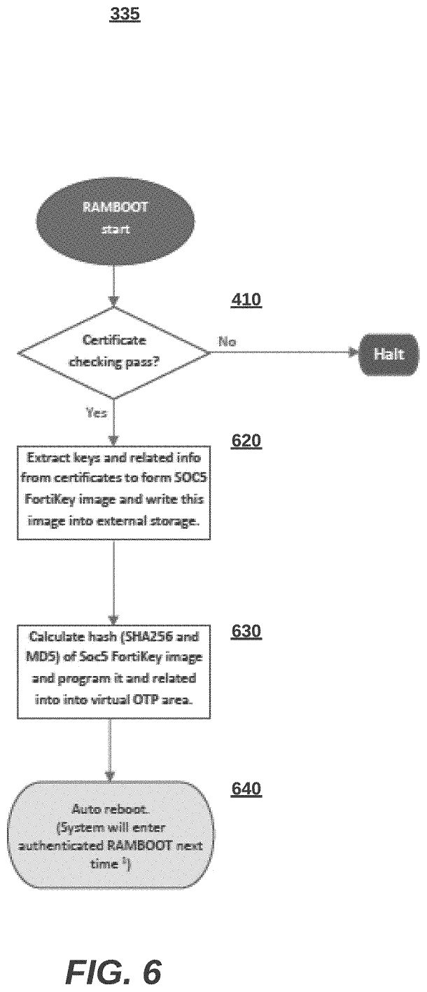

FIG. 6 shows further details concerning enablement of OTP hardware boot up step 525. More specifically, at step 610, a certificate is checked for validity. At step 620, keys extracted are from the certificate for storage in flash. At step 630, a key hash is then calculated from the extracted keys for programming into the virtual OTP for authenticating the virtual RAMBOOT boot up prior to authenticated virtual RAMBOOT bootup. Auto-reboot occurs at step 640.

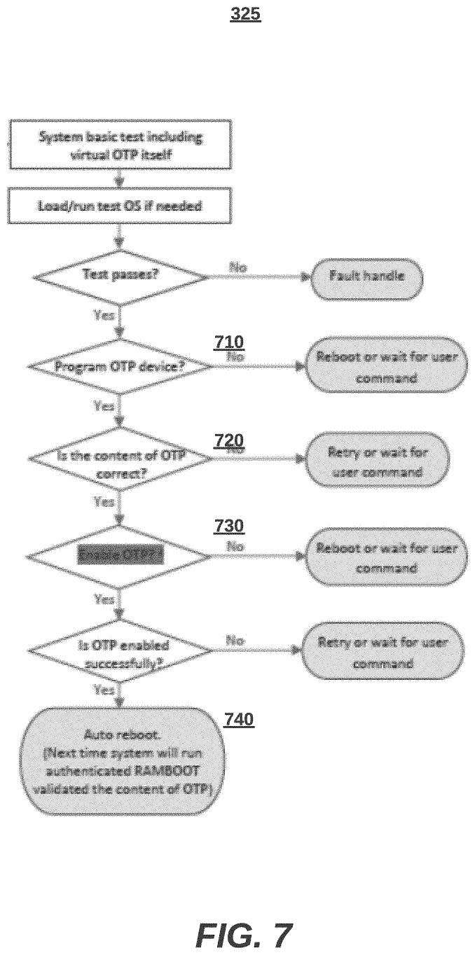

FIG. 7 shows further details about step 515. At step 710, content is transferred from the virtual OTP to the OTP hardware module. At step 720, content of the OTP hardware is verified as being correctly copied and further programmed. At step 730, RAMBOOT bootup is enabled from the OTP hardware module by burning an enablement fuse. Auto-reboot occurs at step 740.

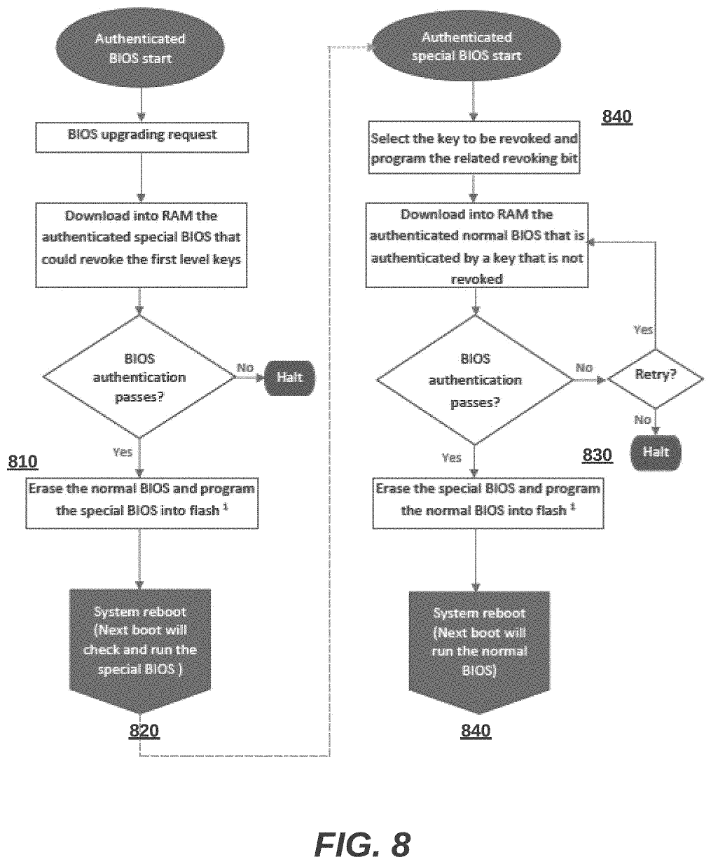

FIG. 8 is a high-level flow diagram illustrating a method for revoking a first level key on an SoC having on-die OTP hardware with two-dimensional key revocation, according to an embodiment.

At step 810, a special BIOS is loaded into flash memory in place of a normal BIOS prior to a reboot of the OTP hardware module. The special BIOS is programmed to identify a status bit to burn corresponding to a revoked key. Each status bit is mapped to the individual key of the plurality of OTP keys. A memory of an OTP module is partitioned into a number of regions to match a number of revocable keys that can only be programmed once. The memory comprises a plurality of regions, each region is dedicated to an individual key of a plurality of OTP keys.

At step 820, the special BIOS is loaded from the flash memory after reboot. A status bit is burned on the key register corresponding to the special BIOS.

At step 830 the BIOS module reloads the normal BIOS into the flash memory in place of the special BIOS prior to a second reboot. The first and second reboots can also be resets or some other mechanism for

At step 840, the normal BIOS runs after the second reboot. The OTP module authenticates the normal BIOS based on the plurality of keys other than the revoked key after the second reboot.

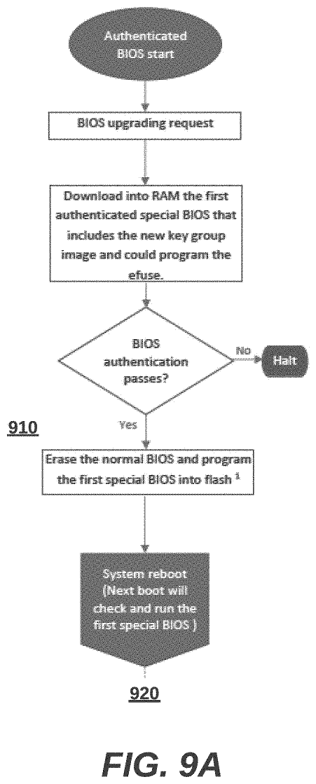

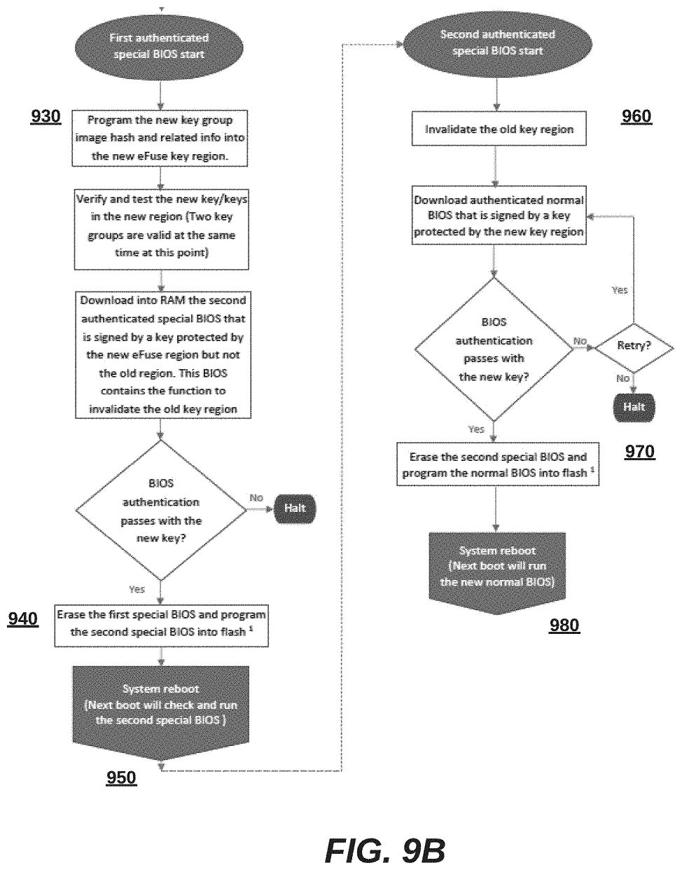

FIGS. 9A & 9B together form a high-level flow diagram illustrating a method for revoking a second level key on an SoC having on-die OTP hardware with two-dimensional key revocation, according to an embodiment

At step 910, a first special BIOS is loaded into flash memory in place of a normal BIOS prior to a reboot of the OTP hardware module. The first special BIOS is programmed to identify a status bit to burn corresponding to a new key group. Each status bit is mapped to the individual key of the plurality of OTP keys. A memory of an OTP module is partitioned into a number of regions to match a number of revocable keys that can only be programmed once. The memory comprises a plurality of regions, each region is dedicated to an individual key group image hash of a plurality of key group image hashes.

At step 920, the first special BIOS is loaded from the flash memory after the reboot. At step 930, the second special BIOS is programmed to load a second key group image hash into a second key storage region. At step 940, the second special BIOS is loaded into flash memory in place of the first special BIOS.

At step 950, the second special BIOS is loaded from the flash memory after the reboot. At step 960, the first key region is invalidated by burning a status bit of the key region status register. At step 970, the normal BIOS into flash memory in place of the second special BIOS.

At step 980, the normal BIOS is loaded from the flash memory after system reboot. Forward operations continue with new keys.

III. Generalities of Description

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use. The scope of the invention is defined by the following claims.

We claim:

1. A system on a chip (SoC) device having on-die one-time programming (OTP) hardware with two-dimensional key revocation allowing revocation of OTP keys, the SoC device comprising:
a substrate for the SoC;
an OTP module within the substate and comprising memory that can only be programmed once, wherein the OTP module comprises:
a plurality of key storage regions, each key storage region dedicated to an individual key of a plurality of OTP keys,
a BIOS module to load a special BIOS into flash memory in place of a normal BIOS prior to a reboot of the OTP hardware module, wherein the special BIOS is programmed to identify a status bit to burn corresponding to a revoked key;
a first key register stored in the OTP module and comprising a plurality of status bits, wherein each status bit maps to the individual key of the plurality of OTP keys;
a key burn module to burn a status bit on the key register corresponding to the special BIOS after the reboot, wherein the BIOS module reloads the normal BIOS into the flash memory in place of the special BIOS prior to a second reboot, wherein the normal BIOS runs after the second reboot, and
wherein the OTP module authenticates the normal BIOS based on the plurality of keys other than the revoked key after the second reboot.

2. The SoC device of claim 1, wherein:
the BIOS module loads a second special BIOS into flash memory in place of the normal BIOS, wherein the second special BIOS is programmed to load a second key group image hash into a second key storage region.

3. The SoC device of claim 1, wherein:
a second key register of the plurality of key registers comprises a second plurality of status bits, wherein each status maps to the individual key of the second plurality of keys used for the second key group image hash, and
wherein the key burn module burns a bit in the second key register to invalidate the first key.

4. The SoC device of claim 1, wherein:
the BIOS module receives a request to upgrade BIOS, and downloads into RAM the special BIOS.

5. The SoC device of claim 1, wherein:
the BIOS module verifies a new key in the new key region.

6. The SoC device of claim 1, wherein:
the BIOS module authenticates the special BIOS with the new key.

7. A method in a system on a chip (SoC) device having on-die one-time programming (OTP) hardware within the substate and comprising memory that can only be programmed once with two-dimensional key revocation allowing revocation of OTP keys, the method comprising the steps of:
partitioning a plurality of key storage regions in an OTP module on the SoC, each key storage region dedicated to an individual key of a plurality of OTP keys,
loading a special BIOS into flash memory in place of a normal BIOS prior to a reboot of the OTP hardware module, wherein the special BIOS is programmed to identify a status bit to burn corresponding to a revoked key;
forming a first key register in the OTP module and comprising a plurality of status bits, wherein each status bit maps to the individual key of the plurality of OTP keys;
burning a status bit on the key register corresponding to the special BIOS after the reboot, wherein the BIOS module reloads the normal BIOS into the flash memory in place of the special BIOS prior to a second reboot, wherein the normal BIOS runs after the second reboot, and
authenticating the normal BIOS based on the plurality of keys other than the revoked key after the second.

8. The method of claim 7, further comprising:
loading a second special BIOS into flash memory in place of the normal BIOS, wherein the second special BIOS is programmed to load a second key group image hash into a second key storage region comprising a second plurality of status bits, wherein each status maps to the individual key of the second plurality of keys used for the second key group image hash; and

9. The method of claim 7,
burning a bit in the second key register to invalidate the first key register.

10. The method of claim 7, further comprising:
receiving a request to upgrade BIOS, and downloads into RAM the special BIOS.

11. The method of claim 7, further comprising:
verifying a new key in the new key region.

12. The method of claim 7, further comprising:
authenticating the special BIOS with the new key.

13. A method in a non-transitory computer-readable media in a system on a chip (SoC) device, the method for having on-die one-time programming (OTP) hardware within the substate and comprising memory that can only be programmed once with two-dimensional key revocation allowing revocation of OTP keys, the method comprising the steps of:
partitioning a plurality of key storage regions in an OTP module on the SoC, each key storage region dedicated to an individual key of a plurality of OTP keys,
loading a special BIOS into flash memory in place of a normal BIOS prior to a reboot of the OTP hardware module, wherein the special BIOS is programmed to identify a status bit to burn corresponding to a revoked key;
forming a first key register in the OTP module and comprising a plurality of status bits, wherein each status bit maps to the individual key of the plurality of OTP keys;
burning a status bit on the key register corresponding to the special BIOS after the reboot, wherein the BIOS module reloads the normal BIOS into the flash memory in place of the special BIOS prior to a second reboot, wherein the normal BIOS runs after the second reboot, and
authenticating the normal BIOS based on the plurality of keys other than the revoked key after.

14. The method of claim 13, further comprising:
loading a second special BIOS into flash memory in place of the normal BIOS, wherein the second special BIOS is programmed to load a second key group image hash into a second key storage region comprising a second plurality of status bits, wherein each status maps to the individual key of the second plurality of keys used for the second key group image hash.

15. The method of claim 13, further comprising:
burning a bit in the second key register to invalidate the first key register

16. The method of claim 13, further comprising:
receiving a request to upgrade BIOS, and downloads into RAM the special BIOS.

17. The method of claim 13, further comprising:
verifying a new key in the new key region.

18. The method of claim 13, further comprising:
authenticating the special BIOS with the new key.
